(19) United States
(12) Patent Application Publication
(10) Pub. No.: US 2007/0095487 A1
(43) Pub. Date: May 3, 2007

(54) Moveable barrier systems

(75) Inventor: Robert Olmsted, Wood Dale, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 11/517,776

(22) Filed: Sep. 8, 2006

Related U.S. Application Data
(60) Provisional application No. 60/716,298, filed on Sep. 12, 2005.

(51) Int. Cl. E05D 15/00

(52) U.S. Cl. 160/201

(57) ABSTRACT

A support assembly for a barrier movable between open and closed positions over an opening comprises a track. The track is attached to the wall for guiding movement of the barrier between substantially vertical closed position and a substantially horizontal open position. A jack shaft assembly is attached to the track and to the barrier for movement thereof. A mounting assembly is attached to the track for receiving a drive unit comprising a motor for supplying power to the jack shaft assembly to move the barrier and for limiting rotational movement of the drive unit.

### CROSS REFERENCES TO RELATED APPLICATIONS

The present application claims the benefit of prior provisional application Ser. No. 60/716,298, entitled “Moveable Barrier Systems,” filed Sep. 12, 2005 and incorporated herein by reference in its entirety.

### BACKGROUND

The present invention relates to controlling the movement of a barrier with respect to an opening in a wall.

Powered barrier operators are known and have been used to automatically move barriers such as garage doors. One type of barrier operator, referred to herein as a jack shaft operator, includes a jack shaft mounted above the door opening and including one or more flexible cables which are attached to the vertically moving door near the bottom thereof.

In known jack shaft operator systems, tracks to guide door movement are mounted to the carpentry frame surrounding a door opening in a wall and the jack shaft is mounted to the support for the tracks and/or to a header above the opening. Cables are also used to connect drums or sprockets on the jack shaft to the door near its bottom. The door is moved by a motor which is attached to the wall near the jack shaft to power rotation thereof. Such coupling may include chains, belts or gears. After assembly, energizing the motor to rotate causes the door to be raised or lowered, depending on the direction of rotation.

The above structure and method may create difficulties in the assembly and use of an automated barrier movement system. The motor housing must be attached to a structural part of the wall, such as wall studs, in order to reliably resist the rotational forces created when the motor is energized. Frequently, there is no structural part where one is needed so the barrier installer must build one. Further, if the wall structure has been covered by for example, plaster or drywall, the finding of a structural part even if present may be difficult and time consuming. In other previous systems, the motor of the operator must be placed above the barrier in order to allow the system to function properly.

### DRAWINGS

FIG. 1 is an elevational view of a portion of a garage showing the movement of a garage door therein;

FIG. 2 shows the attachments of a door guide track in a garage and the attachment of a drive unit and jack shaft thereto;

FIG. 3a shows the attachment of a door guide track in a garage and an alternative attachment of a drive unit;

FIG. 3b shows a side view of a drive unit having a bayonet mount; and

FIG. 3c shows a front view of the drive unit of FIG. 3b.

### DESCRIPTION

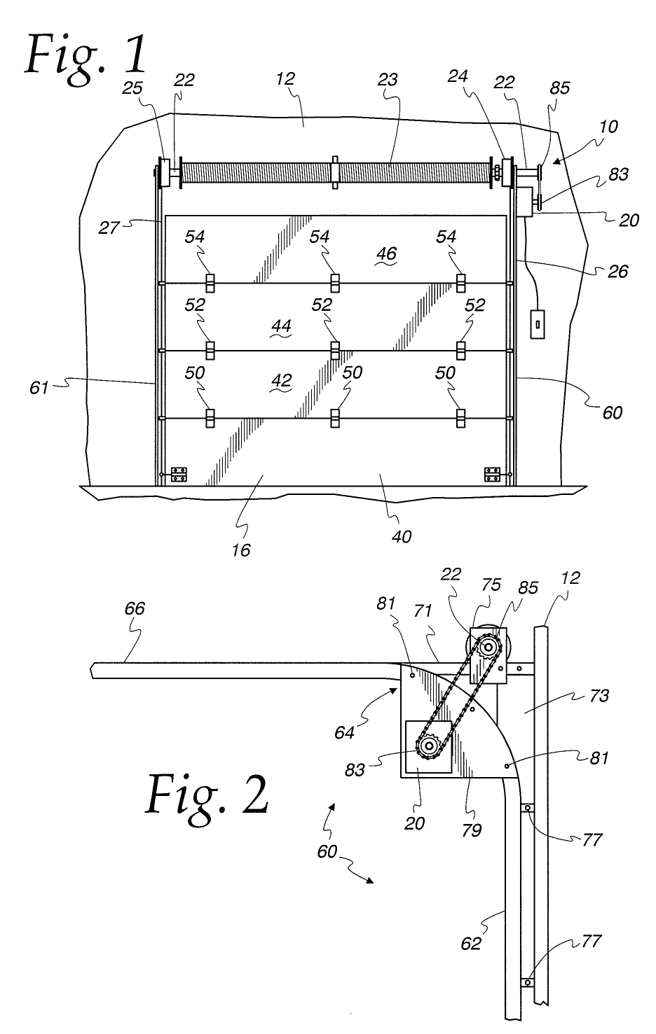

FIG. 1 shows a garage door 16 mounted to cover and uncover an opening (not shown) in a garage wall 12. Door 16 is mounted by rollers in a pair of L shaped tracks 60 and 61. The tracks 60 and 61 are in turn mounted to the carpentry frame (not shown) defining the opening. The barrier is moved by a jack shaft garage door operator generally shown at numeral 10. The jack shaft garage door operator 10 includes a drive unit 20 having a jack shaft 22 coupled thereto to be turned thereby. The jack shaft 22 includes a spring 23. A pull-up cable drum 24 is mounted on the jack shaft 22 to be turned and a pull-up cable 26 is wound around the cable drum 24 to be pulled upwardly.

More particularly, the garage door 16 is a multiple paneled door consisting of a plurality of rectangular panels 40, 42, 44 and 46. The panels 40 and 42 are connected by a plurality of hinges 50. Panels 42 and 44 are connected by a plurality of hinges 54. The door is carried by multiple rollers in a pair of L-shaped tracks. The exemplary L-shaped track 60 shown in FIG. 2 includes a vertical portion 62, a curved portion 64 and a horizontal portion 66. Rollers positioned on respective shafts mounted to the door panels ride in the track 60 and carry the door panels upwardly and downwardly. In operation, the drive unit 20 cooperates with the jack shaft 22 (including the spring 23) to move the garage door 16. For instance, when the door 16 is lowered, the jack shaft 22 (and the spring 23) are rotated to pay out the cables 26 and a corresponding cable 27 at the other side of the door from the pull-up cable drums 24 and 25.

The L shaped track 60, its mounting to wall 12 and the mounting of the drive unit 20 and jack shaft operator 10 is shown in more detail in FIG. 2. Track 60 includes a pair of support members 71 and 73 which add additional support to the curved track section 64 and provide an attachment for jack shaft mounting member 75. Support member 73 also provides an attachment points to wall 12 with a separation therebetween as do stand off attachments 77. Drive unit 20 is attached to track 60 at the curved portion 64 thereof. As shown in FIG. 2 a sheet steel attachment 79 is attached by means of fasteners 81 to the curved portion of track 64 and the drive unit 20 is affixed thereto. Power is conveyed by a motor of drive unit 20 to a pulley 83 which is further coupled to a pulley 85 attached to rotate the jack shaft 22 including the spring 23. In the present embodiment power is conveyed from pulley 83 to pulley 85 of the jack shaft 22 by means of a flexible belt 84 although other flexible or geared coupling means could be used.

Attaching drive unit 20 and jack shaft assembly 10 to the tracks 60 and 61 rather than to the wall provides improved ease of assembly. Prior systems attached the drive unit to the wall which attachment frequently required the location of carpentry members in the wall and/or the construction of such by the garage door assembler. Further, because the placement of the various components in any given location could not be predicted before assembly, a wide array of parts needed to be carried by the assembler. Attachment of the drive unit 20 to the tracks 60 and 61 eliminates the need for support carpentry on the part of the assembler and reduces the parts which may have to be brought to the assembly site by the assembler. In addition, the drive unit 20 can be positioned anywhere relative to the garage door 16 (e.g., even below the door 16).

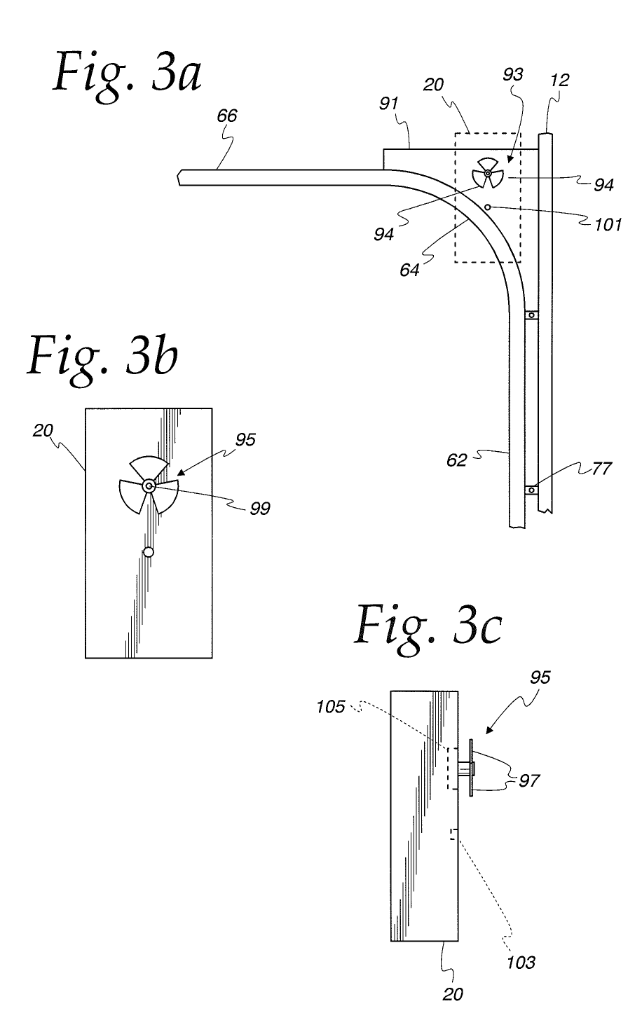

In the preceding embodiment the drive unit 20 is attached to the door guiding track and power is conveyed to the jack shaft 22 by means of a flexible coupling. FIG. 3a-3c show an assembly system in which the drive unit 20 is mounted directly over the end of jack shaft 22 and power is coupled to the jack shaft 22 internally to the drive unit 20 housing. In FIG. 3a, a track consisting of sections 62, 64 and 66 is connected to a garage wall 12 by means of a standoff 77 and a sheet steel support member 91. A female bayonet opening 93 is formed in support 91 to provide a means of attaching the drive unit 20 to the guide track. FIGS. 3b and 3c present front and side views of a drive unit 20 having the mating male portions 95 of a bayonet mount. As best seen in FIG. 3c the bayonet 95 includes flanges 97 which fit into the wing openings 94 of female bayonet opening 93. Thus, in the manner well known for bayonet mounts, the two bayonet portions can be mated and rotated to lock them together. Advantageously, a fastener such as a bolt may be used to connect through a hole 101 in support 91 and attached to a threaded hole 103 in the drive unit. The support 91 may include a conventional bearing for support of the end of jack shaft 22 which protrudes through the opening 93 and into the unit 20 via an opening 99. Power attachment to the jack shaft can then be completed within the drive unit. Alternatively, drive unit 20 may include an operational bearing 105 which provides end support for the jack shaft 22.

While there has been illustrated and described particular embodiments of the present invention, it will be appreciated that numerous changes and modifications will occur to those skilled in the art, and it is intended in the appended claims to cover all those changes and modifications which fall within the true scope of the present invention.

What is claimed is:

1. A support assembly for a barrier movable between open and closed positions over an opening in a wall comprising:
a track attached to the wall for guiding movement of the barrier between substantially vertical closed position and a substantially horizontal open position;
a jack shaft assembly attached to the track and to the barrier for movement thereof; and
a mounting assembly attached to the track for receiving a drive unit comprising a motor for supplying power to the jack shaft assembly to move the barrier and for limiting rotational movement of the drive unit.

2. The support assembly of claim 1 wherein the drive unit is coupled to the jack shaft assembly via a flexible coupling.

3. The support assembly of claim 2 wherein the flexible coupling comprises a flexible belt.

4. The support assembly of claim 1 wherein the jack shaft assembly is coupled to the drive unit at an end of the jack shaft assembly.

5. The support assembly of claim 1 wherein the track is L-shaped and includes a curved portion.

6. The support assembly of claim 5 wherein the mounting assembly is coupled to the track at the curved portion of the track.

7. The support assembly of claim 6 wherein the mounting assembly is coupled to the track such that the drive unit received by the mounting assembly is positioned to be substantially entirely above the curved portion of the track.

8. The support assembly of claim 6 wherein the mounting assembly is coupled to the track such that the drive unit received by the mounting assembly is positioned to be substantially entirely below the curved portion of the track.

9. A method of assembling a movable barrier support structure for a movable barrier which is moved with respect to an opening in a wall comprising:
attaching at least one barrier guiding track to the wall in proximity to the opening;
attaching a jack shaft assembly to the at least one barrier guiding track and to the barrier for movement thereof;
attaching a drive motor to the at least one barrier guiding track; and
coupling a power output of the drive motor to the jack shaft assembly for movement of the barrier.

10. The method of claim 9 wherein coupling a power output of the drive motor comprises coupling the power output to the jack shaft assembly via a flexible coupling.

11. The method of claim 10 wherein the flexible coupling comprises a flexible belt.

12. The method of claim 9 wherein coupling the jack shaft assembly to the drive motor comprises coupling the jack shaft assembly to the drive motor at an end of the jack shaft assembly.

13. The method of claim 9 wherein the at least one barrier guiding track is L-shaped and includes a curved portion.

14. The method of claim 13 wherein attaching the drive motor to the at least one barrier guiding track comprises attaching the drive motor to the at least one barrier guiding track at the curved portion of the at least one barrier guiding track.

15. The method of claim 14 wherein attaching the drive motor to the at least one barrier guiding track comprises attaching the drive motor to the at least one barrier guiding track such that the drive motor is positioned to be substantially entirely above the curved portion of the at least one barrier guiding track.

16. The method of claim 14 wherein attaching the drive motor to the at least one barrier guiding track comprises attaching the drive motor to the at least one barrier guiding track such that the drive motor is positioned to be substantially entirely below the curved portion of the at least one barrier guiding track.
